(19) United States
(12) Patent Application Publication
(10) Pub. No.: US 2013/0307371 A1
(43) Pub. Date: Nov. 21, 2013

(54) CAPACITANCE CHANGE TYPE POWER GENERATION DEVICE

(71) Applicant: Fujifilm Corporation, Tokyo (JP)

(72) Inventor: Yukio SAKASHITA, Ashigarakami-gun (JP)

(73) Assignee: Fujifilm Corporation, Tokyo (JP)

(21) Appl. No.: 13/948,814

(22) Filed: Jul. 23, 2013

Related U.S. Application Data
(63) Continuation of application No. PCT/JP2012/000829, filed on Feb. 8, 2012.

(30) Foreign Application Priority Data
Feb. 9, 2011 (JP) 025906/2011

(51) Int. Cl. H02N 1/00

(52) U.S. Cl. CPC H02N 1/00
USPC 310/300

(57) ABSTRACT

A power generation device includes: a composite layer formed by a dielectric elastomer with ferroelectric particles dispersed therein; and a pair of electrodes disposed on opposite sides of the composite layer, the pair of electrodes being stretchable and compressible along with stretch and compression of the composite layer. The ferroelectric particles have crystal orientability and are orientationally dispersed in the dielectric elastomer, and are polarized in the layer thickness direction of the composite layer.

### TECHNICAL FIELD

The present invention relates to a power generation device that generates electricity when an inter-electrode capacitance is changed.

### BACKGROUND ART

Conventionally, electroactive polymer artificial muscles (EPAM), which are actuators using an electroactive polymer formed by a dielectric elastomer, are developed.

The electroactive polymer actuator converts an electric energy into a mechanical energy. The electroactive polymer actuator is formed by two flexible electrodes and a dielectric elastomer sandwiched between the electrodes. When a potential difference is formed between the electrodes, the elastomer is compressed in the thickness direction and stretched in the plane direction due to an electrostatic force.

In recent years, techniques that reverse this driving operation to convert a mechanical energy into an electric energy to provide a power generation system are being developed (see, S. Chiba et al., “New Opportunites in Electric Generation Using Electroactive Polymer Artificial Muscle (EPAM)” Journal of the Japan Institute of Energy, Vol. 86, PP. 743-747, 2007 (hereinafter, Non-patent Document 1), and Japanese Unexamined Patent Publication Nos. 2008-141840, 2008-053527 and 2009-232677 (hereinafter, Patent Documents 1, 2 and 3, respectively), etc.)

Non-patent Document 1 and Patent Document 1 disclose a power generation apparatus employing the above-described EPAM.

Patent Documents 2 and 3 disclose dielectric rubber layered products that contain a dielectric ceramic exhibiting high permittivity to increase the permittivity of the dielectric elastomer.

On the other hand, Japanese Unexamined Patent Publication No. 2006-131776 (hereinafter, Patent Document 4) proposes a composite member, such as a fiber-reinforced plastic, having a self-diagnosis function for nondestructive inspection of defects inside the member. The composite member is formed by a synthetic resin, which include piezoelectric particles with polarization directions thereof being oriented, and conductive fiber layers. The conductive fiber layers of the composite member serve as electrodes, and the composite member stores electric charges resulting from spontaneous polarization of the piezoelectric particles, thereby forming a capacitive sensor. When vibration is applied to the composite member, the composite member outputs an electric current, which corresponds to an amount of change of capacitance, from the conductive fiber layers. Based on this output signal, distortion or damages occurring in the composite member can be diagnosed.

### DISCLOSURE OF INVENTION

It is conventionally known that, to use a dielectric rubber layer to form an artificial muscle actuator, it is necessary to provide the dielectric rubber layer with high permittivity. According to this idea, the rubber layers in Patent Documents 2 and 3 contain the dielectric particles with high permittivity.

However, the present inventors have concluded through study that preferred conditions about dielectric characteristics differ between when a dielectric rubber layer is used to form an actuator and when a dielectric rubber layer is used to form a power generation device, and that use of the dielectric rubber layer containing the highly dielectric filler taught in Patent Document 2 is not always effective to provide sufficient power generation efficiency.

The self-diagnosis type composite member of Patent Document 4 only needs to have a power generation capacity that is sufficient for the composite member to function as the capacitive sensor, and Patent Document 4 does not study improving the power generation capacity of the composite member to use it as a power generation device.

In view of the above-described circumstances, the present invention is directed to providing a capacitance change-type power generation device with high power generation efficiency.

A capacitance change-type power generation device of the invention includes: a composite layer formed by a dielectric elastomer with a plurality of ferroelectric particles disperse therein; and a pair of electrodes disposed on opposite sides of the composite layer, the pair of electrodes being stretchable and compressible along with stretch and compression of the composite layer, wherein the ferroelectric particles have crystal orientability in the composite layer and are orientationally dispersed in the dielectric elastomer such that the polarization axes of the ferroelectric particles are oriented in the same direction, and are polarized in the layer thickness direction of the composite layer.

The description “have crystal orientability” herein is defined to mean that an orientation rate F measured by the Lotgering method is 50% or more.

The orientation rate F is expressed by equation (i) below:

F(%)=(P−P₀)/(1−P₀)×100 (1).

In the equation (i), P is a ratio of a sum of reflection intensities from the orientated planes to a sum of all the reflection intensities. In the case of (001) orientation, P is a ratio ({ΣI(001)/ΣI(hkl)}) of a sum ΣI(001) of reflection intensities I(001) from the (001) planes to a sum ΣI(hkl) of reflection intensities I(hkl) from individual crystal planes (hkl). For example, in the case of the (001) orientation of perovskite crystals, P=I(001)/[I(001)+I(100)+I(101)+I(110)+I(111)].

P₀ is P of a sample that has a completely random orientation. In the case of a completely random orientation (where P=P₀), F 0%. In the case of a complete orientation (where P=1), F=100%.

It is preferred that the polarization axes of the ferroelectric particles that provide the lowest permittivity are oriented substantially parallel to the layer thickness direction.

It is preferred that a relative permittivity in the polarization direction of the ferroelectric particles is less than 200.

It is preferred that the ferroelectric particles have a particle size in the range from 100 nm to 10 μm.

It is preferred that the dielectric elastomer has a Young's modulus of 100 MPa or less, and more preferably a Young's modulus of 10 MPa or less.

It is preferred that the crystal structure of the ferroelectric particles is one of a perovskite structure, a bismuth layer structure and a tungsten bronze structure. It is preferred that the ferroelectric particles are mainly composed of a lead-free perovskite oxide. It is preferred that the perovskite oxide is a bismuth-containing perovskite oxide.

In the capacitance change-type power generation device of the invention, the ferroelectric particles dispersed in the dielectric elastomer have crystal orientability and are orientationally dispersed such that the polarization axes of the ferroelectric particles are oriented in the same direction, and are polarized in the layer thickness direction of the composite layer. According to this structure, high remanent polarization values of the particles can be achieved due to the crystal orientability of the individual particles. Further, since the polarization axes of the particles are oriented in the same direction, a high remanent polarization value (high surface charge density) of the entire composite layer can be achieved. In addition, in the power generation device of the invention, the elasticity of the dielectric elastomer allows largely changing the distance between the electrodes, thereby achieving improved power generation capacity.

Further, in the case where the polarization axes of the ferroelectric particles that provide the lowest permittivity are oriented substantially parallel to the layer thickness direction of the composite layer, permittivity can be reduced and higher power generation characteristics can be achieved.

### BRIEF DESCRIPTION OF THE DRAWINGS

FIG. 1 shows schematic sectional views in the thickness direction illustrating the structure of a capacitance change type power generation device according to one embodiment of the invention, and

FIG. 2 shows schematic sectional views in the thickness direction illustrating the structure of a layered structure power generation device, which is an approximate model for explaining the principle of power generation.

### DESCRIPTION OF PREFERRED EMBODIMENTS

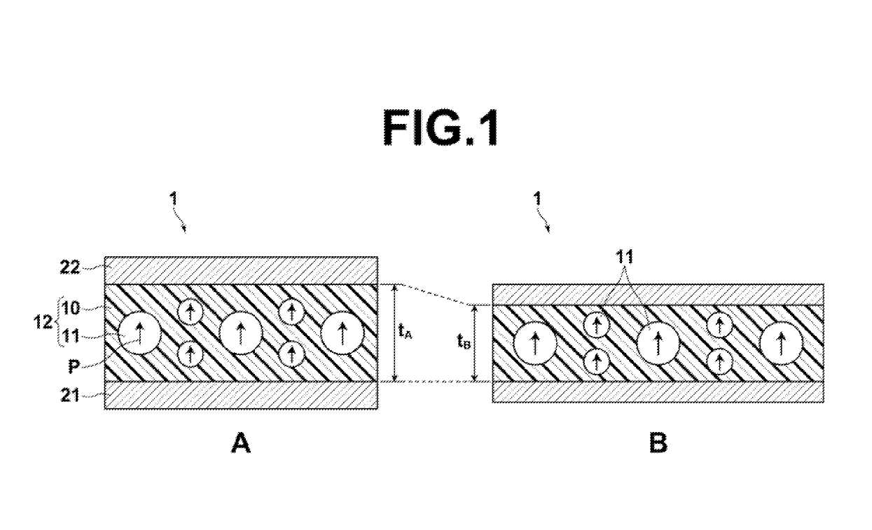

Hereinafter, a capacitance change type power generation device of the invention is described with reference to FIG. 1. FIG. 1 shows schematic sectional views of a power generation device 1 according to one embodiment of the invention, where an uncompressed state (state A) of the device is shown at A and a compressed state (state B) of the device is shown at B. For ease of visual understanding, the elements shown in the drawing are not to scale.

As shown in FIG. 1, the power generation device 1 includes a composite layer 12, which is formed by dispersing ferroelectric particles 11 in a dielectric elastomer 10, and a pair of electrodes 21 and 22, which are disposed on opposite sides of the composite layer 12 and are stretchable and compressible along with stretch and compression of the composite layer 12. In the power generation device 1, the ferroelectric particles 11 have crystal orientability and are orientationally dispersed in the dielectric elastomer 10 such that the polarization axes of the ferroelectric particles 11 are oriented in the same direction, and are polarized in the layer thickness direction of the composite layer 12.

The presence of the orientationally polarized ferroelectric particles provides the composite layer 12 with a very high surface charge density.

With respect to the conventionally studied artificial muscle power generation devices, it is necessary to charge an initial electric energy between the electrodes in advance. In contrast, with respect to the power generation device of the invention, the composite layer has a surface charge resulting from the polarized ferroelectric particles and it is not necessary to charge the initial electric energy.

The lower electrode 21 and the upper electrode 22 are electrically connected to a load (not shown). The power generation device 1 is a capacitance change-type power generation device, where an electric energy is generated by changing a distance between the electrodes 21 and 22 to change the capacitance. An electrostatic field formed by the composite layer 12 electrostatically induces electric charges across the electrodes 21 and 22. In this state, when the shape of the device is changed, the electric charge distribution becomes asymmetric and the inter-electrode capacitance is changed, and a potential difference is formed between the electrodes. Then, electric charge transfer occurs so that the potential difference becomes 0, and thus an electric current flows to the external circuit (load).

When the state of the power generation device 1 is changed from the state A shown at A in FIG. 1, which is a state before a compressive force in the stacking direction of the layers is applied, to the state B shown at B in FIG. 1, which is a state when the compressive force is applied, and is changed from the state B to the state A, a potential difference is formed between the electrodes 21 and 22, and change of the potential difference is extracted as an electric power. Thus, the function as a power generation device is achieved. It should be noted that the external pressure (compressive force) changes the thickness of only the elastomer layer 10, and the shapes of the ferroelectric particles 11 are hardly changed.

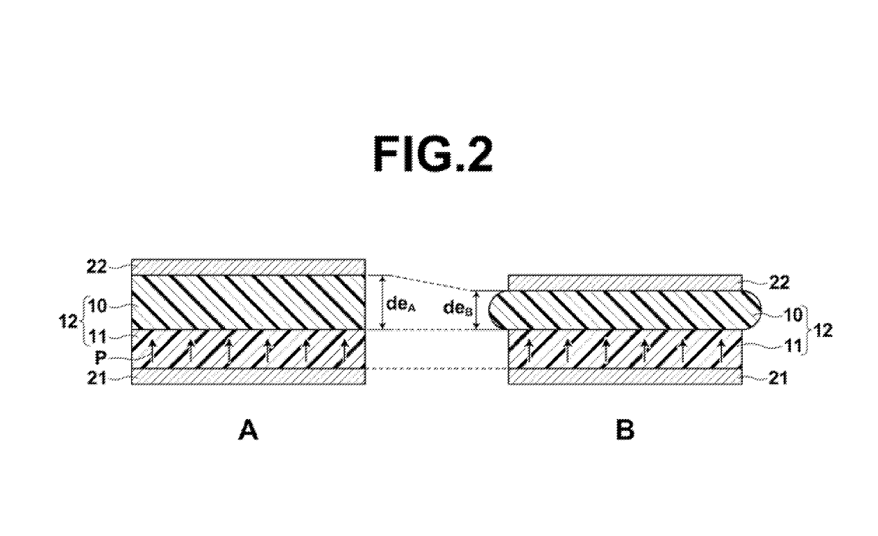

Now, the principle of power generation is described. In the explanation of the principle of power generation, in order to quantitatively estimate influences of physical property values of the ferroelectric material and the elastomer and the amount of deformation on the power generation capacity, calculations are performed approximately by assuming a layered model of an elastomer layer 10 and a ferroelectric layer 11, as shown in FIG. 2, by gathering the ferroelectric particles in the composite to the side of one of the electrodes. FIG. 2 shows schematic sectional views of a power generation device which is the layered model for explaining the principle of power generation, where an uncompressed state (state A) of the device is shown at A and a compressed state (state B) of the device is shown at B. The elements shown in FIG. 2 which are equivalent to the elements of the device shown in FIG. 1 are denoted by the same reference symbols. It should be noted that the thickness of the elastomer layer and the thickness of the ferroelectric layer of the approximate model can be estimated from volume fractions of the elastomer and the ferroelectric particles in the composite.

Assuming that a frequency of the compressive force applied between the electrodes is f, then a power generation capacity P of the device of the invention is defined as equation (1) below:

$$P = \frac{1}{2} \cdot Δ Q \cdot Δ V \cdot f . \qquad ( 1 )$$

In equation (1), ΔQ is a surface charge density on the surface of the electrode, which moves when the state is changed from the state A to the state B, and is expressed by an amount of change of the surface charge of the elastomer layer. That is, ΔQ=Δqₑ=q_{eB}−q_{eA}, where q_{eA} is a surface charge density of the elastomer in the state A, and q_{eB} is a surface charge density of the elastomer after the electric charge transfer that occurs after the state is changed to the compressed state B.

ΔV is an amount of change of the potential difference when the state is changed from the state A to the state B. Assuming that the thickness of the ferroelectric layer does not change, the amount of change of the potential difference can be regarded as an amount of change of the potential difference at the elastomer layer, and is expressed by ΔV≈ΔVₑ=V_{eA}−V_{eB}, where V_{eA} is a potential at the electrode on the elastomer side in the state A, and V_{eB} is a potential at the electrode on the elastomer side in the compressed state B before the electric charge transfer.

The electric charge density q_{eA} on the surface of the elastomer layer electrostatically induced by dielectric polarization of the ferroelectric layer and an electric charge density q_{f} on the surface of the ferroelectric layer in the state A are expressed as equation (2) below:

$${q}_{e} = \frac{1}{( \frac{{d}_{e A}}{{d}_{f}} \cdot \frac{{ɛ}_{f}}{{ɛ}_{e}} + 1 )} \cdot {q}_{f} . \qquad ( 2 )$$

From the above relational expressions, the power generation capacity P is expressed as equation (3) below:

$$P \approx \frac{1}{2} \cdot \frac{{ɛ}_{f}}{{ɛ}_{0} \cdot {ɛ}_{e}^{2} \cdot {d}_{f}} \cdot \frac{{( {d}_{eA} - {d}_{eB} )}^{2}}{( \frac{{d}_{eB} \cdot {ɛ}_{f}}{{d}_{f} \cdot {ɛ}_{e}} + 1 ) {( \frac{{d}_{eA} \cdot {ɛ}_{f}}{{d}_{f} \cdot {ɛ}_{e}} + 1 )}^{2}} \cdot {q}_{f}^{2} \cdot A \cdot f , \qquad ( 3 )$$

(where d_{eA} is a thickness of the elastomer layer in the state A, d_{eB} is a thickness of the elastomer layer in the state B, d_{f} is a thickness of the ferroelectric layer (which is assumed to be unchanged between the states A and B), A is an area of opposing electrodes, ∈ₑ is a relative permittivity of the elastomer, ∈_{f} is a relative permittivity of the ferroelectric material, and ∈₀ is a permittivity of vacuum.)

It can be seen from the equation (3) above that the ferroelectric material 11 preferably has a high surface charge density q_{f} and a low relative permittivity ∈_{f} in view of obtaining a high power generation capacity.

Further, it is clear that a larger difference (a larger amount of change of the thickness) between the thickness d_{eA} of the elastomer layer in the state A and the thickness d_{eB} of the elastomer layer in the state B results in a larger power generation capacity. It should be noted that the difference between the thickness d_{eA} of the elastomer layer in the state A and the thickness d_{eB} of the elastomer layer in the state B is equivalent to a difference between a thickness t_{A} of the composite layer in the state A and a thickness t_{B} of the composite layer in the state B of the power generation device shown in FIG. 1.

Since the change of capacitance is achieved by large stretch and compression in the thickness direction by an external force, as described above, it is preferred that the dielectric elastomer layer 10 has a small Young's modulus and can provide a large thickness change relative to the applied force. In particular, the Young's modulus of the dielectric elastomer layer 10 is preferably 100 MPa or less, and more preferably 10 MPa or less. It should be noted that the external force is used to stretch and compress the dielectric elastomer layer 10, and almost no external force is applied to the dielectric polarization layer formed by a ferroelectric material and the thickness of the dielectric polarization layer is hardly changed. Therefore, it is believed that the piezoelectric effect of the dielectric polarization layer is scarcely working.

Since the change of capacitance is achieved by stretching and compressing the dielectric elastomer layer 10 (composite layer 12) largely in the thickness direction with an external force, as described above, it is preferred that the dielectric elastomer 10 has a small Young's modulus and can provide a large thickness change relative to the applied force. In particular, the Young's modulus of the dielectric elastomer 10 is preferably 100 MPa or less, and more preferably 10 MPa or less. The external force (compressive force) applied to the device to stretch the composite layer 12 is absorbed by the stretch of the dielectric elastomer 10, and almost no external force is applied to the ferroelectric particles. Therefore, the shape of the ferroelectric particles 11 is hardly changed. It is therefore believed that, in the composite layer of the power generation device 1, the piezoelectric effect is scarcely working.

Examples of the material forming the dielectric elastomer 10 include: thermosetting elastomers, such as acrylic rubber, acrylonitrile-butadiene rubber, isoprene rubber, silicone rubber and fluororubber, which are synthetic rubbers; and thermoplastic elastomers, such as polystyrene elastomers, polyolefin elastomers and polyurethane elastomers.

A larger volume fraction of the ferroelectric particles 11 results in a higher surface charge density of the composite layer 12. However, if the volume fraction of the ferroelectric particles 11 is excessively large, the composite layer has a high Young's modulus and may have poor durability. Therefore, it is preferred that the volume fraction of the ferroelectric particles 11 in the composite layer 12 is about 10 to 60%.

The material forming the ferroelectric particles 11 is not particularly limited, as long as the ferroelectric particles 11 have crystal orientability and are orientationally dispersed such that the polarization axes of the ferroelectric particles 11 are oriented in the same direction, and can be polarized in the layer thickness direction of the composite layer 12. The material forming the ferroelectric particles 11 may be an organic ferroelectric material, an inorganic ferroelectric material or a composite material thereof.

However, in view of obtaining higher power generation efficiency, it is preferred to use a ferroelectric material having a higher remanent polarization value as the ferroelectric particles. Therefore, it is preferred that the ferroelectric particles 11 are mainly composed of an inorganic ferroelectric material that can provide a high remanent polarization value. Forming the ferroelectric particles by an inorganic ferroelectric material is also preferred in view of heat resistance, and it is more preferred to use an inorganic ferroelectric material having a high Curie temperature.

To provide a higher remanent polarization value, it is preferred that the polarization axes of the crystal-oriented ferroelectric particles 11 are substantially parallel to the layer thickness direction.

Examples of the crystal structure of the inorganic ferroelectric material that can provide a high remanent polarization value (i.e., has excellent ferroelectricity) include a perovskite structure, a bismuth layer structure and a tungsten bronze structure. Among them, a perovskite structure is preferred.

As perovskite oxides with excellent ferroelectricity, lead-based perovskite oxides are known. In view of environmental load, however, a material mainly composed of a lead-free perovskite oxide is preferred, and a bismuth-containing perovskite oxide is more preferred.

Specific examples of the perovskite oxide include: as lead-based perovskite oxides, lead-containing compounds, such as lead titanate, lead zirconate titanate (PZT), lead zirconate, lead lanthanum titanate, lead lanthanum zirconate titanate, lead magnesium niobate-lead zirconate titanate, lead nickel niobate-lead zirconate titanate, zinc niobate-lead zirconate titanate, etc., and mixed crystal systems thereof; as lead-free perovskite oxides, barium titanate, strontium barium titanate, bismuth sodium titanate, bismuth potassium titanate, sodium niobate, potassium niobate, lithium niobate, etc., and mixed crystal systems thereof; and perovskite oxides having a composition expressed by general formula (PX) below (which may contain inevitable impurities)

(BiₓA₁₋ₓ)(B_{y},C_{1-y})O₃ (PX).

(In the general formula (PX), A is an A-site element with an average ionic valence of two other than Pb, B is a B-site element with an average ionic valence of three, C is a B-site element with an average ionic valence greater than three, A, B and C are independently one or two or more metal elements, O is oxygen, B and C has different compositions from each other, 0.6≦x≦1.0, x−0.2≦y≦x, and a ratio of the total mole number of A-site elements to a mole number of the oxygen atoms and a ratio of the total mole number of B-site elements to the mole number of the oxygen atoms are respectively 1:3 as a standard; however, these ratios may be varied from the standard molar ratio within a range where a perovskite structure is provided.)

On the other hand, even when a high remanent polarization value is provided, a high relative permittivity results in a low power generation capacity. Therefore, it is preferred that the polarization axes parallel to the thickness direction provide the lowest permittivity when the ferroelectric particles 11 are polarized.

By orienting the ferroelectric particles such that the polarization axes thereof that provide a high remanent polarization value and a low relative permittivity are substantially parallel to the layer thickness direction, a composite layer with high surface charge density and low permittivity can be provided.

With respect to a ferroelectric material having a perovskite structure, for example, the orientation of the polarization axes that provide a high remanent polarization value and a low relative permittivity is the <001> direction (c-axis) for tetragonal crystals, the <110> direction for orthorhombic crystals, and the <111> direction for rhombohedral crystals.

For example, a c-axis oriented perovskite oxide, such as PZT, can provide a remanent polarization value of 10 μC/cm² or more and a relative permittivity of 400 or less or preferably less than 200, and is therefore preferred.

The particle size of the ferroelectric particles is preferably about 100 nm to 10 μm. The particle size herein refers to the maximum length of a particle.

A small particle size results in low ferroelectricity. Therefore, it is preferred that the particle size is 100 nm or more. On the other hand, if the particle size is excessively large, the ferroelectric particles cannot follow the stretch and compression of the dielectric elastomer and may be detached. Therefore, it is preferred that the particle size is 10 μm or less.

The shape of the ferroelectric particles is not particularly limited, as long as the ferroelectric particles are granular, and may be any shape, such as a spherical shape, a plate-like shape, or a whisker-like shape.

The orientational dispersion of the ferroelectric particles in the dielectric elastomer can be achieved, for example, by the following method.

Plate-like ferroelectric particles (with the c-axes thereof oriented in the thickness direction of the plate) formed by c-axis oriented crystals (having a tetragonal perovskite structure) are dispersed in the dielectric elastomer, and in this state, the dispersion is applied onto the electrode and cured. This allows orienting the thickness direction of the plate-like particles perpendicular to the plane of the electrode.

Alternatively, ferroelectric particles having crystal orientability are dispersed in the dielectric elastomer and the dispersion is applied onto the electrode. Thereafter, in a semi-cured state where the dielectric elastomer is not completely cured, polarization is applied. With this, the ferroelectric particles are moved so that the direction of spontaneous polarization of the ferroelectric particles is the same as the direction of the electric field, thereby achieving orientation of the particles in the elastomer.

The method used to polarize the ferroelectric particles in the composite layer is not particularly limited. Besides a usual polarization method using electrodes, corona discharge treatment, etc., may be used. In view of preventing characteristics deterioration due to depolarization, it is preferred that the ferroelectric material has a high coercive field value. In view of heat resistance and characteristics deterioration due to depolarization, it is preferred that the ferroelectric material has a high Curie temperature.

The material forming the lower electrode 21 and the upper electrode 22 is not particularly limited, as long as the lower electrode 21 and the upper electrode 22 are made of an electrically conductive material that can be stretched and compressed along with stretch and compression of the composite layer 12 and can follow change of the composite layer.

A specific example of the material forming the lower electrode 21 and the upper electrode 22 is an electrically conductive material formed by a base rubber, such as a silicon-based, modified silicon-based, acryl-based, polychloroprene-based, polysulfide-based, polyurethane-based or polyisobutyl-based rubber, with an electrically conductive filler added thereto.

Preferred examples of the electrically conductive filler include carbon materials, such as carbon fiber, carbon nanofiber (CNF), carbon nanotube (CNT), Ketjenblack® or acetylene black, which is one of electrically conductive carbon blacks, graphite, etc., and metallic materials, such as gold, silver, platinum, etc.

The thicknesses of the lower electrode 21 and the upper electrode 22 are not particularly limited, as long as the electrodes have a thickness that is enough to provide sufficient electrical conductivity for extracting an electric current generated when the potential difference between the electrodes is changed. The thicknesses of the electrodes can be determined depending on the electrical conductivity of the electrode material used and the size of the entire power generation device 1, and may preferably in the range from 1 to 1000 μm in a natural state, for example.

The structure of the capacitance change-type power generation device 1 is as described above.

A method used to produce the power generation device 1 is not particularly limited, as long as the power generation device 1 has the above-described structure.

The power generation device 1 employs the composite layer that contains the ferroelectric particles 11, and the ferroelectric particles 11 have crystal orientability and are orientationally dispersed in the dielectric elastomer in a direction in which the polarization axes of many of the particles are oriented in the same direction. Further, the polarization axes are polarization axes that provide the lowest relative permittivity, and are oriented substantially parallel to the layer thickness direction. According to this structure, very high surface charge density and low permittivity are provided, and therefore higher power generation characteristics can be achieved. Further, a dielectric elastomer, in general, has a Young's modulus in the range from several MPa to several tens MPa and largely deforms when an external force is applied thereto, and therefore high power generation capacity can be achieved. Further, by using the electrodes formed by an electrically conductive material that can be stretched and compressed along with stretch and compression of the composite layer 12 and can follow change of the composite layer, deformation of the dielectric elastomer is not hindered, and high power generation capacity can be achieved.

In contrast, in Patent Document 4 mentioned in the “BACKGROUND ART” section, an epoxy resin, which has very high Young's modulus of 2 to 5 GPa, is used as the synthetic resin. Further, an electrically conductive fiber, in general, is not much stretchable. It is therefore believed that the composite material taught in Patent Document 4 cannot provide sufficiently large deformation for providing high power generation capacity.

In the case where an inorganic material, such as a perovskite oxide, is used as the ferroelectric material, the power generation device 1 having higher heat resistance and higher power generation efficiency can be provided when compared to one using a resin material.

### Modification

The present invention is not limited to the above-described embodiment, and various modifications may be made to the present invention as long as the gist of the invention is not changed.

For example, a plurality of strip-like devices may be arranged on a single substrate and the devices may be connected in series or in parallel to form a power generation device with improved power generation capacity.

### INDUSTRIAL APPLICABILITY

The power generation device of the invention is applicable to power generation using a natural energy, such as wave power, water power or wind power, as well as power generation by a walking person with power generation devices embedded in shoes or a floor, power generation by a running automobile with power generation devices embedded in tires, etc.

What is claimed is:

1. A capacitance change-type power generation device comprising:
a composite layer formed by a dielectric elastomer with a plurality of ferroelectric particles disperse therein; and
a pair of electrodes disposed on opposite sides of the composite layer, the pair of electrodes being stretchable and compressible along with stretch and compression of the composite layer,
wherein the ferroelectric particles have crystal orientability and are orientationally dispersed in the dielectric elastomer such that the polarization axes of the ferroelectric particles are oriented in the same direction, and are polarized in the layer thickness direction of the composite layer.

2. The power generation device as claimed in claim 1, wherein polarization axes of the ferroelectric particles that provide the lowest permittivity are oriented substantially parallel to the layer thickness direction.

3. The power generation device as claimed in claim 1, wherein a relative permittivity in the polarization direction of the ferroelectric particles is less than 200.

4. The power generation device as claimed in claim 2, wherein a relative permittivity in the polarization direction of the ferroelectric particles is less than 200.

5. The power generation device as claimed in claim 1, wherein the ferroelectric particles have a particle size in the range from 100 nm to 10 μm.

6. The power generation device as claimed in claim 2, wherein the ferroelectric particles have a particle size in the range from 100 nm to 10 μm.

7. The power generation device as claimed in claim 1, wherein the dielectric elastomer has a Young's modulus of 100 MPa or less.

8. The power generation device as claimed in claim 2, wherein the dielectric elastomer has a Young's modulus of 100 MPa or less.

9. The power generation device as claimed in claim 1, wherein the crystal structure of the ferroelectric particles is one of a perovskite structure, a bismuth layer structure and a tungsten bronze structure.

10. The power generation device as claimed in claim 2, wherein the crystal structure of the ferroelectric particles is one of a perovskite structure, a bismuth layer structure and a tungsten bronze structure.

11. The power generation device as claimed in claim 1, wherein the ferroelectric particles are mainly composed of a lead-free perovskite oxide.

12. The power generation device as claimed in claim 2, wherein the ferroelectric particles are mainly composed of a lead-free perovskite oxide.
